(19) United States
(12) Patent Application Publication
(10) Pub. No.: US 2014/0172501 A1
(43) Pub. Date: Jun. 19, 2014

(54) System Apparatus Circuit Method and Associated Computer Executable Code for Hybrid Content Recommendation

(71) Applicant: JINNI MEDIA LTD., Rosh Ha'ayin (IL)

(72) Inventors: Ram Meshulam, Yavne (IL); Mordechai Mori Rimon, Jerusalem (IL); Izhak Ben Zaken, Shimshit (IL)

(73) Assignee: JINNI MEDIA LTD., Rosh Ha'ayin (IL)

(21) Appl. No.: 14/016,859

(22) Filed: Sep. 3, 2013

Related U.S. Application Data
(63) Continuation-in-part of application No. 12/859,248, filed on Aug. 18, 2010.
(60) Provisional application No. 61/867,651, filed on Aug. 20, 2013.

(51) Int. Cl. G06Q 30/02

(52) U.S. Cl. CPC G06Q 30/0201
USPC 705/7.29

(57) ABSTRACT

Disclosed are systems, apparatuses, circuits, methods and computer executable code sets for generating and providing hybrid content recommendations. One or more recommendation engines are collaboratively arranged based on the conditions of a recommendation request. The collaborative recommendation engine arrangement is used for generating a set of content recommendations for the request.

### RELATED APPLICATIONS

This application is: (1) a continuation-in-part of and claims priority from U.S. patent application Ser. No. 12/859,248 filed with the USPTO on Aug. 18, 2010; and (2) a non-provisional of and claims priority from U.S. Provisional Pat. App. No. 61/867,651 filed with the USPTO on Aug. 20, 2013. Both, and all, of which are hereby incorporated by reference in their entirety.

### FIELD OF THE INVENTION

The present invention generally relates to the fields of content matching and recommendation. More specifically, the present invention relates to a system, apparatus, circuit, method and associated computer executable code for generating and providing hybrid content recommendations to a user or group of users.

### BACKGROUND

In the field of content matching and recommendation, recommender systems are active information filtering systems that attempt to present to the user information items (film, television, music, books, news, web pages) the user is interested in. These systems add or remove information items to the information flowing towards the user. Recommender systems typically use collaborative filtering, semantic reasoning, rule-based operations and/or other approaches—some were shown to be more effective in certain scenarios while others were shown to be more effective in different scenarios.

Taking the above into account, there clearly remains a need, in the fields of content matching and recommendation, for systems apparatuses circuits methods and associated computer executable code sets that introduce unique approaches to content recommendation, adapted to utilize and collaborate two or more recommendation algorithms for generating better matching sets of content recommendations across a range of recommendation request conditions.

### SUMMARY OF THE INVENTION

Unless specifically stated otherwise, as apparent from the following discussions, it is appreciated that throughout the specification discussions utilizing terms such as “user”, “viewer”, “requestor”, or the like, may refer to: (1) a person or group of persons requesting a content recommendation set(s), (2) a person or group of persons for which a content recommendation set(s) is intended, (3) a person or group of persons requesting a content recommendation set(s) either intended for himself/their-selves or for another/others, and/or (4) any combination thereof.

Furthermore, unless specifically stated otherwise, as apparent from the following discussions, it is appreciated that throughout the specification discussions utilizing the terms “recommendation algorithm”, “recommendation engine”, or the like, may refer to any recommendation generating and/or recommendation generation supporting methods or systems. Accordingly, recommendation generation supporting actions such as, but not limited to: (1) the tagging of content items; (2) the generation of taste profile(s); and/or (3) the aggregation, standardization and/or clustering of content related data—may be described as being part of a recommendation algorithm or as being executed by a recommendation engine.

The present invention includes methods, circuits, apparatuses, systems and associated computer executable code for providing content recommendations to a user or group of users. According to embodiments, each of one or more separate content recommendation algorithms, sometime embodied as recommendation engines, may be selected and/or collaboratively used in order to provide a set of content recommendations across a range of recommendation request conditions (RRC), wherein the RRC may include: (1) a quantity of available information relating to the recommendation requestor(s) (e.g. viewer); and/or (2) a quantity of available information relating to recommendable content from one or more content catalogs or repositories. Selection of recommendation algorithms, to be used individually or in a collaborative manner, may be at least partially based upon the RRC at the time of the recommendation request. According to further embodiments, two or more collaboratively used algorithms may be referred to as collaborative algorithms and may be used either in sequence, in parallel or in a nested/interdependent manner.

According to a first collaborative arrangement, the outputs of collaborative algorithms used or run in parallel, namely individual recommendation sets generated by each algorithm, may be selectively combined and/or blended, wherein combining and/or blending may include: (1) combing all recommendations generated from each of the recommendation sets generated by individual algorithms into a single combined or final recommendation set; and (2) selecting and combining only specific recommendations from each of the individual recommendation sets into a final recommendation set. Recommendation item selection, for combination into a final recommendation set, may be based on an estimation of reliability or accuracy for the recommendation items, such that only items with an estimated reliability or accuracy above a static or dynamically set threshold value/level are selected.

According to a second collaborative arrangement, the output of a first collaborative algorithm may be at least partially used as an input to a second collaborative algorithm run in series with the first. For example, a first algorithm may generate one or more characterization tags (e.g. metadata) for one or more content items, thereby making it possible for a second algorithm to cross-correlate the one or more characterization tags on the one or more content items with a requestor's known preferences (e.g. viewer taste profile) in order to determine whether the one or more content items should be included in a final recommendation set. The first algorithm, may be a content characterization algorithm which may operate on the basis of: (1) feature identification in the content items, (2) data repository crawling algorithm which uses an identifier on the content items to search through online descriptions of the content item and use natural language processing techniques to extract characterization information from the online descriptions, and (3) copying characterization tags from other content items when both content items were either selected for viewing or otherwise noted by the same or similar persons.

According to a third collaborative arrangement, a first algorithm may instance, call, trigger or otherwise use a collaborative algorithm in a nested/interdependent manner, as needed by the first algorithm. For example, a first algorithm may generate an initial, content recommendation set to a requestor/viewer based on external and/or environmental factors relating to his recommendation request. Incoming viewer feedback (e.g. to the initial recommendation) may be utilized by a second algorithm for generating a new taste profile for the viewer. Based on the newly created profile, the second algorithm, or a third algorithm(s), may provide the viewer with a second more personalized recommendation set. Additional viewer feedback may be utilized by the second algorithm for further enhancing and updating the viewer taste profile that may result in incrementally personalized and enhanced recommendation sets.

According to a fourth collaborative arrangement, a first algorithm may aggregate and standardize raw data, and cluster it under logically equal abstract content items. A second meta-algorithm—that may also comprise or combine elements of the first, second and/or third arrangements—may generate recommendations based on the standardized and clustered data sets, regardless of their raw data sources.

Which collaborative arrangement and/or combination of collaborative arrangements are used in response to a given content recommendation request may depend on the RRC at the time of the given request. More specifically, when little or no information relating to the recommendation requestor(s) or to content items in the content catalog is available, algorithm selection may favor one or more recommendation algorithms: (1) requiring minimal input (e.g. cold-start algorithms); and/or (2) which are a combination of collaborative algorithms adapted to: (a) derive, extrapolate or otherwise estimate RRC related information; and (b) generate a recommendation set from the catalog based on the derived, extrapolated or otherwise estimated RRC related information.

When little or no information relating to the recommendation requestor(s) (per-viewer information) is available but information relating to content items in the content catalog (per-content information) is available, algorithm selection may initially favor one or more per-content based recommendation algorithms requiring minimal per-viewer information (e.g. cold-start algorithms); and may subsequently shift towards favoring one or more personalized recommendation algorithms (e.g. taste-profile based algorithms) as requestor related information is acquired (e.g. from feedbacks to previously recommended content items).

When little or no information relating to content items in the content catalog (per-content information) is available but information relating to the recommendation requestor(s) (per-viewer information) is available, algorithm selection may initially utilize one or more algorithms (e.g. non-semantic content similarity algorithms) to learn about (e.g. tag) content items in the content catalog; and then may use one or more content tags based recommendation algorithms (e.g. taste-based recommendation algorithm).

As information relating to the requestor and/or relating to content items within the content catalog accumulates and grows, algorithm selection and/or selection of collaborative algorithm arrangements, or any combination thereof, may start favoring those algorithms or algorithm arrangements which use relatively more information and provide relatively more accurate or reliable recommendations than those algorithms requiring minimal inputs. According to further embodiments, a recommendation system may include any one or any combination of the above mentioned collaborative arrangements. Accordingly, the collaborative arrangement and/or combination of collaborative arrangements used in response to a given content recommendation request may generate a set of content recommendations for a given person or group of persons (therein after “viewer”).

According to some embodiments, exemplary recommendation engines utilized as part of implementing the collaborative algorithm arrangements may include: (1) Non-Semantic Content Similarity recommendation engines (e.g. Collaborative Filtering Engines) for providing content recommendations based on consumption history related data, such as: ‘viewers who consumed item X were inclined to also consume item Y’; (2) Semantic Content Similarity recommendation engines for providing content recommendations of tagged content items that have substantially similar tagging characteristics as previously consumed or preferred tagged content items; (3) Taste Profile Based recommendation engines for providing content recommendations matching a viewer's taste profile. The viewer's taste profile may be based on personal viewer-related information and attributes (e.g. provided by the viewer) and/or the viewer's feedbacks to previously suggested content items; and/or (4) Cold Start recommendation engines for providing content recommendations based on External and/or Environmental factors relating to the recommendation request, such as the time of day or when, or geographical location where, the request was made.

According to some embodiments, a set of recommendable content items (e.g. movies, series episodes, music, etc.) may be processed by each of two or more separate recommendation algorithms to produce, by each algorithm, a set of content recommendations. Each recommendation algorithm may be implemented by a separate recommendation engine of a recommendation system, and each recommendation algorithm may use or factor a unique set of viewer parameters and/or a unique set of content parameters, relating to one or more characteristics of the viewer and/or relating to one or more characteristics of the recommendable content.

According to some embodiments, a parameter set factored by each algorithm may be either partially or completely different from a parameter set factored by another algorithm. A parameter set factored by a first algorithm may include at least one common parameter with a parameter set factored by a second algorithm. Which algorithm or algorithms, out of all available algorithms, are selected and used at a given instance for generating content recommendations for a given viewer may depend upon which viewer parameters and/or which content parameters are available to the system at that given instance. Content recommendation sets generated by each of two or more used algorithms may be selectively combined or blended to produce a blended or final recommendation set.

According to some embodiments, each content item generated by a given recommendation algorithm may be assigned a value related to an estimated reliability factor of the recommendation. The blended or final content recommendation set may include only recommendations having a reliability factor above a certain threshold. The content items within a blended or final content recommendation set may be ordered at least partially based on the estimated reliability factor associated with each item.

According to further embodiments, one or more content parameters and/or content tags (e.g. Metadata) may be copied to, and associated with, a given content item from another content item responsive to a common selection of the two content items by the same persons or similarly inclined persons. Additionally, one or more content parameters and/or content tags may be associated with a given content item based on viewer feedback.

According to some embodiments, non-tagged content items may be tagged with tags of previously tagged content items that were determined, by the Non-Semantic Content Similarity engine, to be substantially similar to the non-tagged items. Newly tagged content items may then be considered for inclusion, in recommendation sets generated by tagged content based recommendation engines such as Semantic Content Similarity engines, viewer Taste Profile based recommendation engines and/or other tagged content items clients.

According to some embodiments, a pre-defined viewer taste profile, for un-profiled or new viewers, may be generated based on external and environmental factors related to their recommendation requests (e.g. time of day, weather or location). An initial recommendation set may be selected based on the pre-defined viewer taste profile. Viewer information (e.g., feedbacks to the initial recommendation set) may be utilized for updating and enhancing respective viewer taste profile(s) and then used for generating incrementally personalized recommendation sets. The process may be repeated as additional viewer feedbacks are received, to generate a more enhanced/refined and personalized viewer profile based on which better matching recommendation sets may be generated and offered to the viewer.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

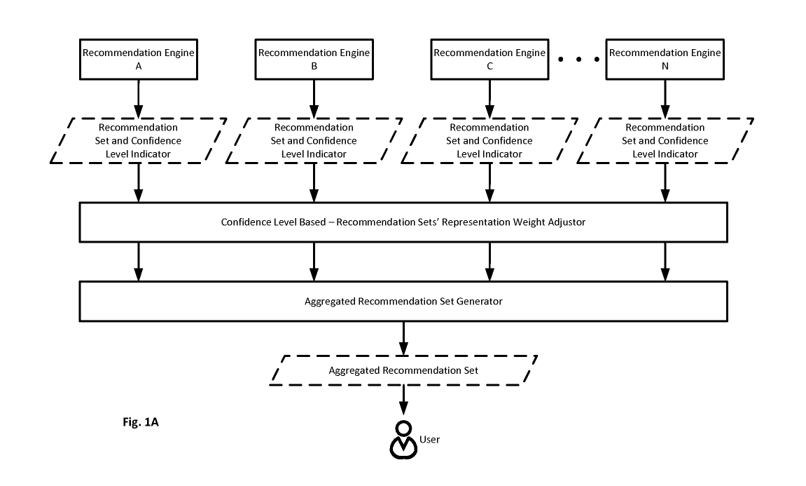

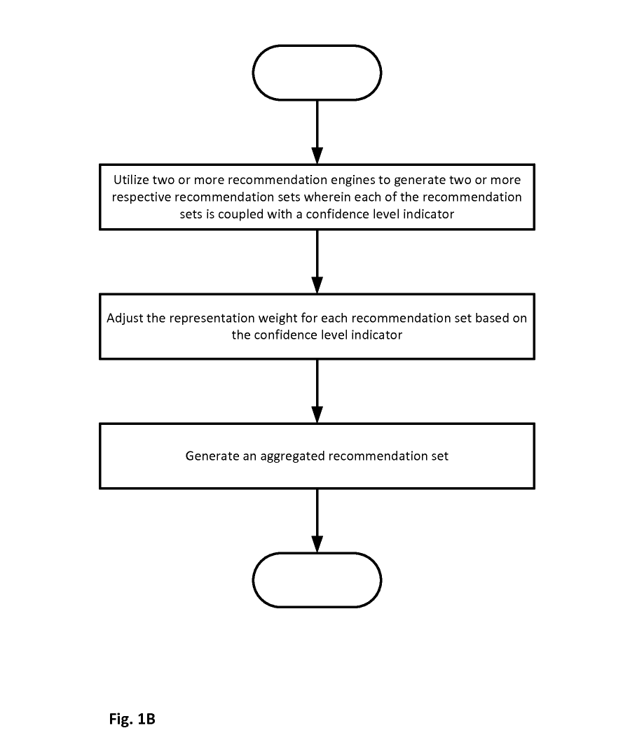

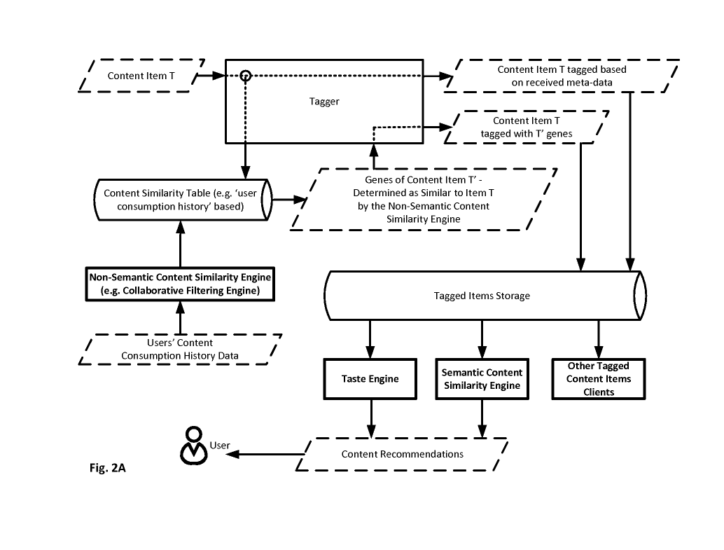

In FIG. 1A there is shown, in accordance with some embodiments of the present invention, a block diagram and an exemplary operation flow of a hybrid content recommendation system, wherein content recommendations from two or more separate content recommendation engines are blended to yield an aggregated recommendation set;

In FIG. 1B there is shown, in accordance with some embodiments of the present invention, a flow chart showing the main steps taken as part of an exemplary method, for hybrid content recommendation, implemented by the system of FIG. 1A;

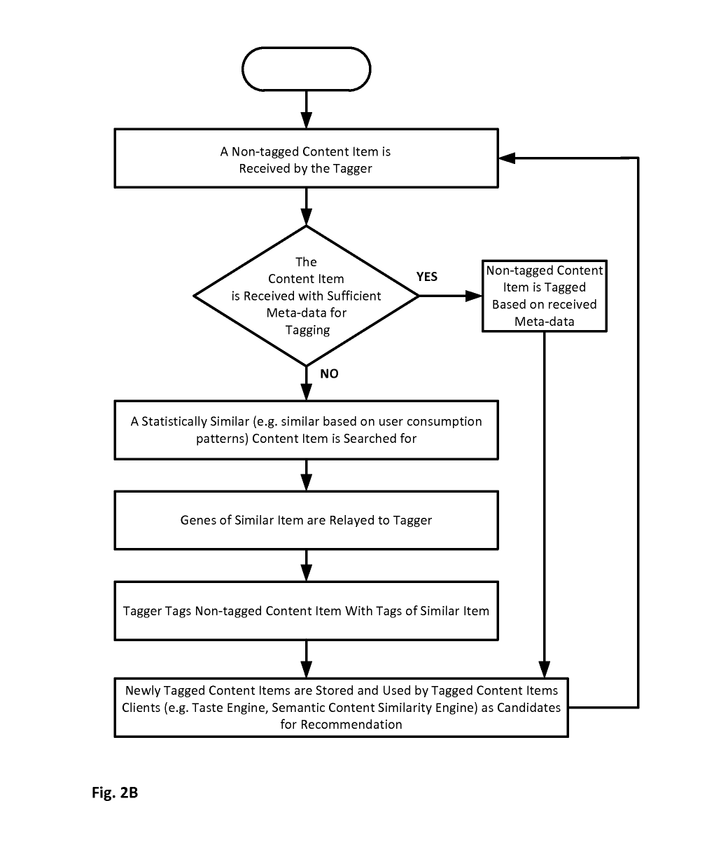

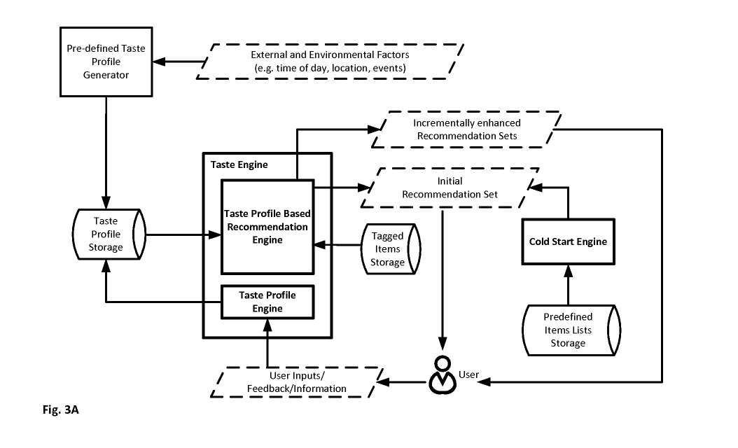

In FIG. 2A there is shown, in accordance with some embodiments of the present invention, a block diagram and an exemplary operation flow of a hybrid content recommendation system, wherein one recommendation engine generates content parameters and/or content tags (e.g. Metadata) which is utilized by a second recommendation engine;

In FIG. 2B there is shown, in accordance with some embodiments of the present invention, a flow chart showing the main steps taken as part of an exemplary method, for hybrid content recommendation, implemented by the system of FIG. 2A;

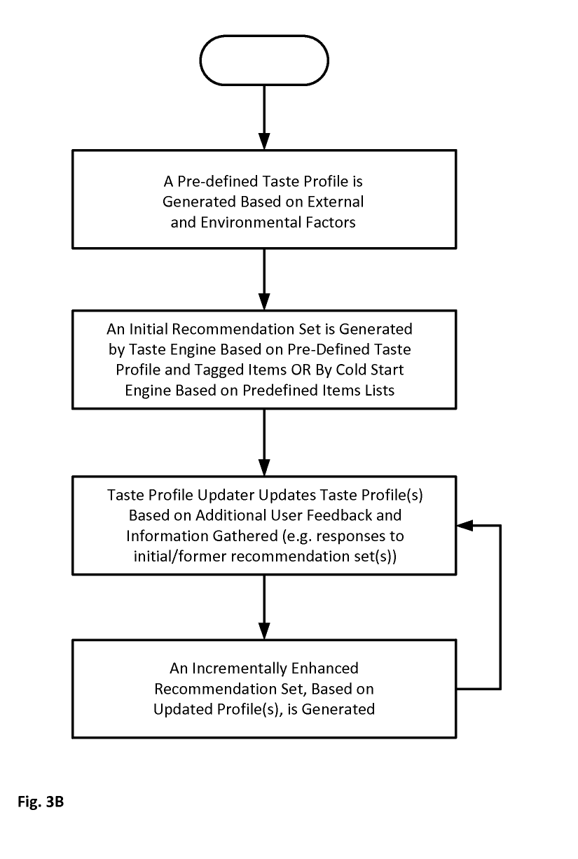

In FIG. 3A there is shown, in accordance with some embodiments of the present invention, a block diagram and an exemplary operation flow of a hybrid content recommendation system, wherein two recommendation engines are combined into one hybrid recommendation system;

In FIG. 3B there is shown, in accordance with some embodiments of the present invention, a flow chart showing the main steps taken as part of an exemplary method, for hybrid content recommendation, implemented by the system of FIG. 3A;

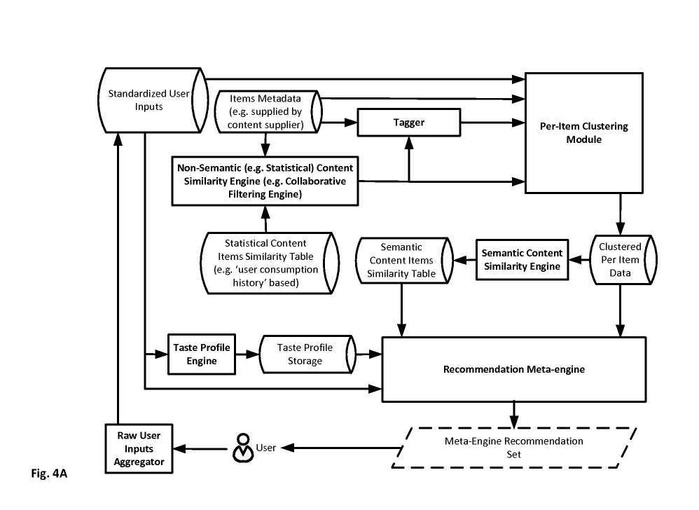

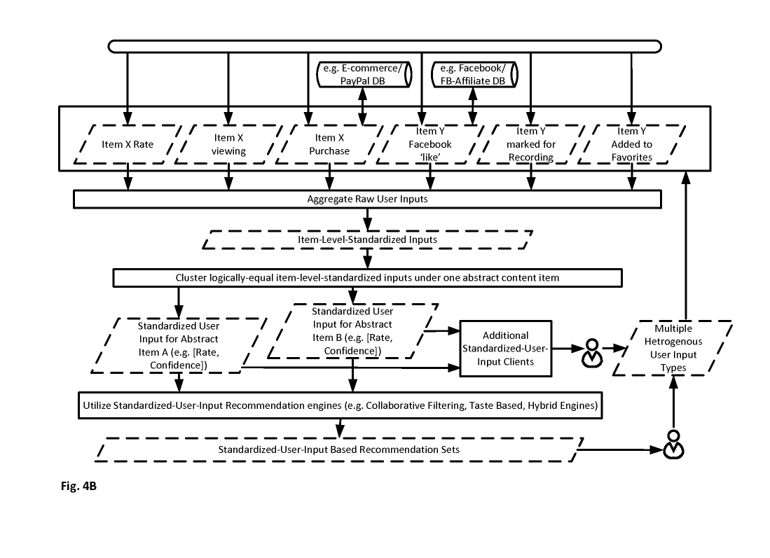

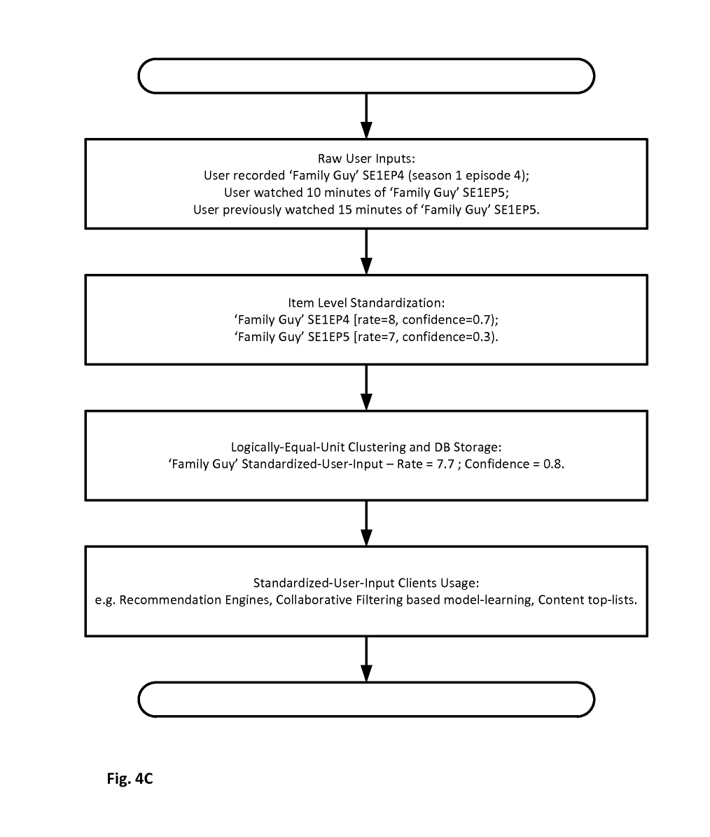

In FIG. 4A there is shown, in accordance with some embodiments of the present invention, a block diagram and an exemplary operation flow of a hybrid content recommendation system, wherein standardized viewer inputs, viewer taste profiles, clustered content items data and/or semantic content similarity data are utilized by a recommendation meta-engine for providing content recommendations;

In FIG. 4B there is shown, in accordance with some embodiments of the present invention, a flow chart showing the main steps taken as part of an exemplary method, for hybrid content recommendation, implemented by the system of FIG. 4A;

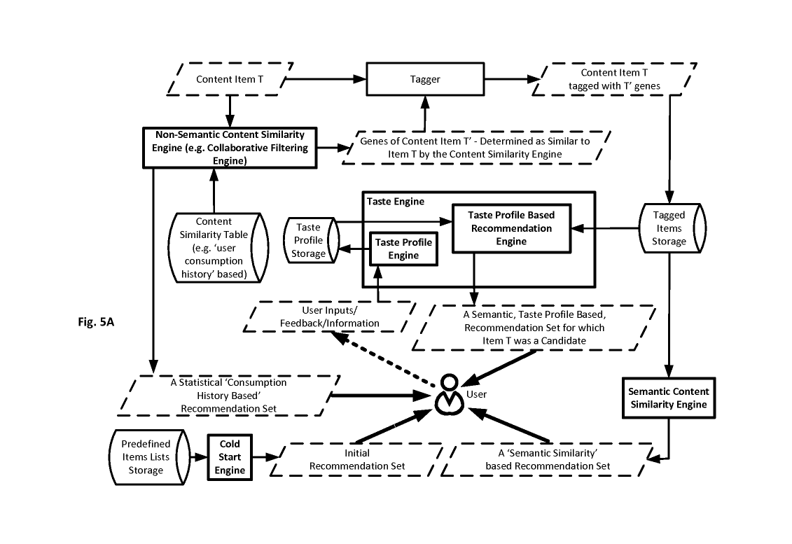

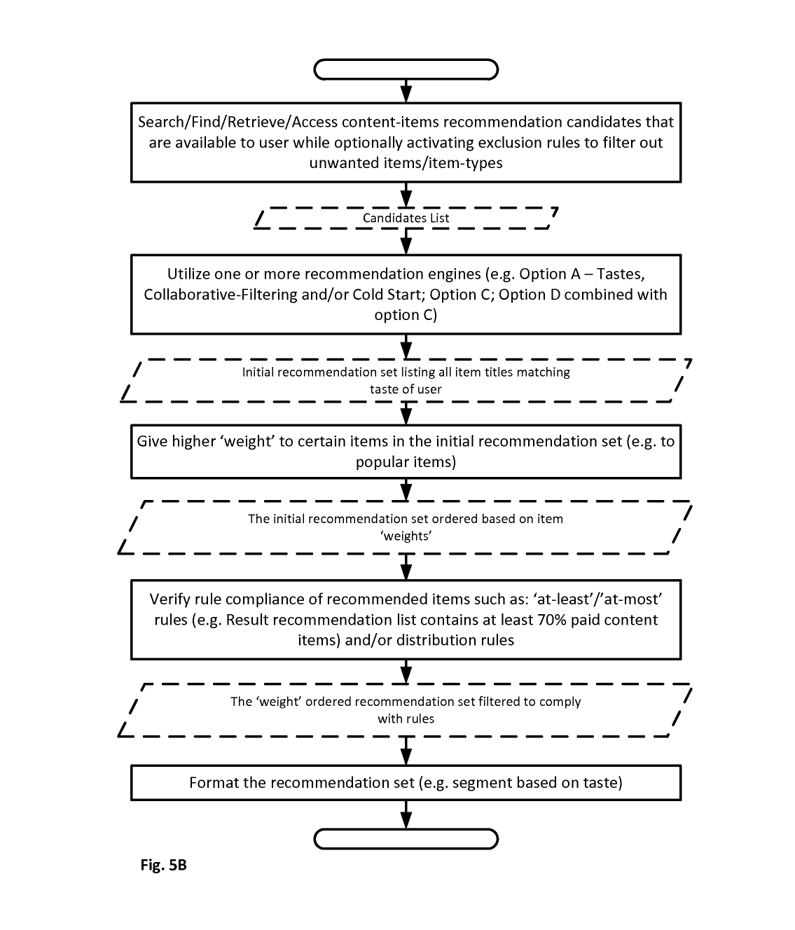

In FIG. 4C there is shown, in accordance with some embodiments of the present invention, a flowchart of a specific example, demonstrating the work of a hybrid standardized-viewer-input based content recommendation system; In FIG. 5A there is shown, in accordance with some embodiments of the present invention, a block diagram and an exemplary operation flow of a hybrid content recommendation system configuration, wherein: Cold Start, Non-Semantic Content Similarity, Semantic Content Similarity and Taste Profile Based recommendation engines are integrated into a single system; and

In FIG. 5B there is shown, in accordance with some embodiments of the present invention, a flow chart showing the main steps taken as part of an exemplary method, for hybrid content recommendation, implemented by the system of FIG. 5A.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention includes methods, circuits, apparatuses, systems and associated computer executable code for providing content recommendations to a user or group of users. According to embodiments, each of one or more separate content recommendation algorithms, sometime embodied as recommendation engines, may be selected and/or collaboratively used in order to provide a set of content recommendations across a range of recommendation request conditions (RRC), wherein the RRC may include: (1) a quantity of available information relating to the recommendation requestor(s) (e.g. viewer); and/or (2) a quantity of available information relating to recommendable content from one or more content catalogs or repositories. Selection of recommendation algorithms, to be used individually or in a collaborative manner, may be at least partially based upon the RRC at the time of the recommendation request. According to further embodiments, two or more collaboratively used algorithms may be referred to as collaborative algorithms and may be used either in sequence, in parallel or in a nested/interdependent manner.

According to a first collaborative arrangement, the outputs of collaborative algorithms used or run in parallel, namely individual recommendation sets generated by each algorithm, may be selectively combined and/or blended, wherein combining and/or blending may include: (1) combing all recommendations generated from each of the recommendation sets generated by individual algorithms into a single combined or final recommendation set; and (2) selecting and combining only specific recommendations from each of the individual recommendation sets into a final recommendation set. Recommendation item selection, for combination into a final recommendation set, may be based on an estimation of reliability or accuracy for the recommendation items, such that only items with an estimated reliability or accuracy above a static or dynamically set threshold value/level are selected.

According to a second collaborative arrangement, the output of a first collaborative algorithm may be at least partially used as an input to a second collaborative algorithm run in series with the first. For example, a first algorithm may generate one or more characterization tags (e.g. metadata) for one or more content items, thereby making it possible for a second algorithm to cross-correlate the one or more characterization tags on the one or more content items with a requestor's known preferences (e.g. viewer taste profile) in order to determine whether the one or more content items should be included in a final recommendation set. The first algorithm, may be a content characterization algorithm which may operate on the basis of: (1) feature identification in the content items, (2) data repository crawling algorithm which uses an identifier on the content items to search through online descriptions of the content item and use natural language processing techniques to extract characterization information from the online descriptions, and (3) copying characterization tags from other content items when both content items were either selected for viewing or otherwise noted by the same or similar persons.

According to a third collaborative arrangement, a first algorithm may instance, call, trigger or otherwise use a collaborative algorithm in a nested/interdependent manner, as needed by the first algorithm. For example, a first algorithm may generate an initial, content recommendation set to a requestor/viewer based on external and/or environmental factors relating to his recommendation request. Incoming viewer feedback (e.g. to the initial recommendation) may be utilized by a second algorithm for generating a new taste profile for the viewer. Based on the newly created profile, the second algorithm, or a third algorithm(s), may provide the viewer with a second more personalized recommendation set. Additional viewer feedback may be utilized by the second algorithm for further enhancing and updating the viewer taste profile that may result in incrementally personalized and enhanced recommendation sets.

According to a fourth collaborative arrangement, a first algorithm may aggregate and standardize raw data, and cluster it under logically equal abstract content items. A second meta-algorithm—that may also comprise or combine elements of the first, second and/or third arrangements—may generate recommendations based on the standardized and clustered data sets, regardless of their raw data sources.

Which collaborative arrangement and/or combination of collaborative arrangements are used in response to a given content recommendation request may depend on the RRC at the time of the given request. More specifically, when little or no information relating to the recommendation requestor(s) or to content items in the content catalog is available, algorithm selection may favor one or more recommendation algorithms: (1) requiring minimal input (e.g. cold-start algorithms); and/or (2) which are a combination of collaborative algorithms adapted to: (a) derive, extrapolate or otherwise estimate RRC related information; and (b) generate a recommendation set from the catalog based on the derived, extrapolated or otherwise estimated RRC related information.

When little or no information relating to the recommendation requestor(s) (per-viewer information) is available but information relating to content items in the content catalog (per-content information) is available, algorithm selection may initially favor one or more per-content based recommendation algorithms requiring minimal per-viewer information (e.g. cold-start algorithms); and may subsequently shift towards favoring one or more personalized recommendation algorithms (e.g. taste-profile based algorithms) as requestor related information is acquired (e.g. from feedbacks to previously recommended content items).

When little or no information relating to content items in the content catalog (per-content information) is available but information relating to the recommendation requestor(s) (per-viewer information) is available, algorithm selection may initially utilize one or more algorithms (e.g. non-semantic content similarity algorithms) to learn about (e.g. tag) content items in the content catalog; and then may use one or more content tags based recommendation algorithms (e.g. taste-based recommendation algorithm).

As information relating to the requestor and/or relating to content items within the content catalog accumulates and grows, algorithm selection and/or selection of collaborative algorithm arrangements, or any combination thereof, may start favoring those algorithms or algorithm arrangements which use relatively more information and provide relatively more accurate or reliable recommendations than those algorithms requiring minimal inputs. According to further embodiments, a recommendation system may include any one or any combination of the above mentioned collaborative arrangements. Accordingly, the collaborative arrangement and/or combination of collaborative arrangements used in response to a given content recommendation request may generate a set of content recommendations for a given person or group of persons (therein after “viewer”).

According to some embodiments, exemplary recommendation engines utilized as part of implementing the collaborative algorithm arrangements may include: (1) Non-Semantic Content Similarity recommendation engines (e.g. Collaborative Filtering Engines) for providing content recommendations based on consumption history related data, such as: ‘viewers who consumed item X were inclined to also consume item Y’; (2) Semantic Content Similarity recommendation engines for providing content recommendations of tagged content items that have substantially similar tagging characteristics as previously consumed or preferred tagged content items; (3) Taste Profile Based recommendation engines for providing content recommendations matching a viewer's taste profile. The viewer's taste profile may be based on personal viewer-related information and attributes (e.g. provided by the viewer) and/or the viewer's feedbacks to previously suggested content items; and/or (4) Cold Start recommendation engines for providing content recommendations based on External and/or Environmental factors relating to the recommendation request, such as the time of day or when, or geographical location where, the request was made.

According to some embodiments, a set of recommendable content items (e.g. movies, series episodes, music, etc.) may be processed by each of two or more separate recommendation algorithms to produce, by each algorithm, a set of content recommendations. Each recommendation algorithm may be implemented by a separate recommendation engine of a recommendation system, and each recommendation algorithm may use or factor a unique set of viewer parameters and/or a unique set of content parameters, relating to one or more characteristics of the viewer and/or relating to one or more characteristics of the recommendable content.

According to some embodiments, a parameter set factored by each algorithm may be either partially or completely different from a parameter set factored by another algorithm. A parameter set factored by a first algorithm may include at least one common parameter with a parameter set factored by a second algorithm. Which algorithm or algorithms, out of all available algorithms, are selected and used at a given instance for generating content recommendations for a given viewer may depend upon which viewer parameters and/or which content parameters are available to the system at that given instance. Content recommendation sets generated by each of two or more used algorithms may be selectively combined or blended to produce a blended or final recommendation set.

According to some embodiments, each content item generated by a given recommendation algorithm may be assigned a value related to an estimated reliability factor of the recommendation. The blended or final content recommendation set may include only recommendations having a reliability factor above a certain threshold. The content items within a blended or final content recommendation set may be ordered at least partially based on the estimated reliability factor associated with each item.

According to further embodiments, one or more content parameters and/or content tags (e.g. Metadata) may be copied to, and associated with, a given content item from another content item responsive to a common selection of the two content items by the same persons or similarly inclined persons. Additionally, one or more content parameters and/or content tags may be associated with a given content item based on viewer feedback.

According to some embodiments, non-tagged content items may be tagged with tags of previously tagged content items that were determined, by the Non-Semantic Content Similarity engine, to be substantially similar to the non-tagged items. Newly tagged content items may then be considered for inclusion, in recommendation sets generated by tagged content based recommendation engines such as Semantic Content Similarity engines, viewer Taste Profile based recommendation engines and/or other tagged content items clients.

According to some embodiments, a pre-defined viewer taste profile, for un-profiled or new viewers, may be generated based on external and environmental factors related to their recommendation requests (e.g. time of day, weather or location). An initial recommendation set may be selected based on the pre-defined viewer taste profile. Viewer information (e.g., feedbacks to the initial recommendation set) may be utilized for updating and enhancing respective viewer taste profile(s) and then used for generating incrementally personalized recommendation sets. The process may be repeated as additional viewer feedbacks are received, to generate a more enhanced/refined and personalized viewer profile based on which better matching recommendation sets may be generated and offered to the viewer.

In FIG. 1A there is shown, in accordance with some embodiments of the present invention, a block diagram and an exemplary operation flow of a hybrid content recommendation system, wherein content recommendations from two or more separate content recommendation engines are blended to yield an aggregated recommendation set. In response to a content recommendation request, separate recommendation sets are generated by several recommendation engines (A-N). Each of the recommendation sets includes a set of recommended content items (e.g. titles), and an estimated reliability factor for each of the content items in the recommendation set and/or for the entire set.

Based on the estimated reliability factors a relative representation weight of each of the recommendation sets in the aggregated recommendation set is adjusted. An aggregated recommendation set in which recommendation sets that received a higher weight also receive a higher relative representation is generated and relayed to the viewer.

In FIG. 1B there is shown, in accordance with some embodiments of the present invention, a flow chart showing the main steps taken as part of an exemplary method for hybrid content recommendation, wherein content recommendations from two or more separate content recommendation engines are blended to yield an aggregated recommendation set.

In FIG. 2A there is shown, in accordance with some embodiments of the present invention, a block diagram and an exemplary operation flow of a hybrid content recommendation system, wherein one recommendation engine generates content parameters and/or content tags (e.g. Metadata) which is utilized by a second recommendation engine. Tags of tagged content item T′ that is determined as substantially similar to content item T, by a Non-Semantic Content Similarity Engine (e.g. based on viewers' content consumption history), are copied to and associated with content item T. Content item T, now tagged with item T′ tags, is then added to a tagged content items storage database, as a candidate for recommendation by ‘tagged items’ based recommendation engines such as Semantic Content Similarity recommendation engines and/or Taste Profile Based recommendation engines.

According to some embodiments, T′ may be one of the content items the user has given feedback on (e.g., rated). In such cases, the associated tags may be used to increase the accuracy of the recommendations by being added to, and thus increasing, the accuracy of the viewer's profile.

In FIG. 2B there is shown, in accordance with some embodiments of the present invention, a flow chart showing the main steps taken as part of an exemplary method for hybrid content recommendation, wherein one recommendation engine generates content parameters and/or content tags (e.g. Metadata) which is utilized by a second recommendation engine.

In FIG. 3A there is shown, in accordance with some embodiments of the present invention, a block diagram and an exemplary operation flow of a hybrid content recommendation system, wherein two recommendation engines are combined into one hybrid recommendation system. Based on External and/or Environmental factors relating to a recommendation request the Cold Start recommendation engine provides a first, initial, content recommendation set to the viewer. Incoming viewer feedback is utilized by a Taste Profile Engine for generating a new viewer taste profile. Based on the newly created profile, the Taste Profile Based recommendation engine is able to provide the viewer with a second, taste profile based, more personalized recommendation set. Any additional viewer feedback is utilized by the Taste Profile Engine for enhancing and updating the viewer taste profile, thus enabling the Taste Profile Based recommendation engine to generate and provide incrementally personalized and enhanced recommendation sets.

In FIG. 3B there is shown, in accordance with some embodiments of the present invention, a flow chart showing the main steps taken as part of an exemplary method for hybrid content recommendation, wherein two recommendation engines are combined into one hybrid recommendation system.

In FIG. 4A there is shown, in accordance with some embodiments of the present invention, a block diagram and an exemplary operation flow of a hybrid content recommendation system, wherein standardized viewer inputs, viewer taste profiles, clustered content items data and/or semantic content similarity data are utilized by a recommendation meta-engine for providing content recommendations. Raw user inputs are standardized and aggregated into item-level (e.g. specific episodes of specific shows) inputs by a Raw Viewer Inputs Aggregator. A Per-Item Clustering Module then clusters logically-equal or logically-related per-item inputs into clusters of data inputs relating to specific abstract content item types (e.g. a specific show). The recommendation meta-engine then utilizes one or more recommendation engines (e.g. Collaborative Filtering, Taste Based, Hybrid Engines) to generate and provide recommendation sets based on the clustered standardized-user-inputs.

In FIG. 4B there is shown, in accordance with some embodiments of the present invention, a flow chart showing the main steps taken as part of an exemplary method for hybrid content recommendation, wherein standardized viewer inputs, viewer taste profiles, clustered content items data and/or semantic content similarity data are utilized by a recommendation meta-engine for providing content recommendations.

In FIG. 4C there is shown, in accordance with some embodiments of the present invention, a flowchart of a specific example, demonstrating the work of a hybrid standardized-viewer-input based content recommendation system. Initially, raw viewer inputs pertaining to specific viewer behaviors (i.e. recorded, watched, previously watched) and specific content items (i.e. ‘family guy’, season no., episode no.) are received. Raw inputs pertaining to specific content items are then standardized to yield rate and rate-confidence values for each specific content item. Logically equal inputs (i.e. all pertaining to the ‘family guy’ show) are clustered yielding a standardized-user-input-rate and a respective confidence-rate for the show (i.e. family guy). The resulting standardized-user-input is then utilized by various standardized-user-input clients such as, but not limited to, recommendation engines.

In FIG. 5A there is shown, in accordance with some embodiments of the present invention, a block diagram and an exemplary operation flow of a hybrid content recommendation system configuration, wherein: Cold Start, Non-Semantic Content Similarity, Semantic Content Similarity and Taste Profile Based recommendation engines are integrated into a single system for providing content recommendations to the viewer.

Based on External and/or Environmental factors relating to the recommendation request, such as the time of day or when, or geographical location where the request was made, the Cold Start recommendation engine provides initial content recommendation sets to the viewer. The Non-Semantic Content Similarity Engine generates and provides statistical ‘consumption history based’ recommendation sets' to the viewer, and further provides a tagger with the genes, of tagged content items—statistically determined as substantially similar to new non-tagged content items. In the present example, content item T′ is determined by the Non-Semantic Content Similarity Engine to be substantially similar to non-tagged content item T. Accordingly, genes of content item T′ are relayed to the tagger and used for tagging content item T. Now tagged, content item T is stored in a tagged items storage database accessed by tagged content items clients—the Semantic Content Similarity and Taste Profile Based recommendation engines—in order to generate tagged content based recommendation sets to the viewer. Viewer's feedbacks to some or all of the recommendation sets provided by the different recommendation engines are utilized by a Taste Profile Engine for building a taste profile, or enhancing an already built taste profile, of the feedback providing viewer. As the viewer taste profile is enhanced, with each additional feedback, better matching recommendations may be generated and provided by the Taste Profile Based recommendation engine.

In FIG. 5B there is shown, in accordance with some embodiments of the present invention, a flow chart showing the main steps taken as part of an exemplary method for hybrid content recommendation, comprising: (1) searching for viewer-available content items and compiling a content candidates list; (2) utilizing one or more content recommendation algorithms, or content recommendation algorithm collaborative arrangement(s), to generate a content recommendation set; (3) giving higher weight to certain (e.g. popular) items in the generated recommendation set and ordering the recommendation set based on the resulting content-items' weights; (4) verifying that the recommended items comply with business rules such as financial or content distribution related rules, resulting in filtered, rule complying, set of content recommendations; rules may be item specific related (e.g. no items banned for distribution in china) or item-set-mix related (e.g. at least/no-more-than 70% of items are paid-content); and (5) Formatting the resulting content recommendation set prior to presentation to viewer (e.g. segmenting based on viewer ‘mood’).

According to some embodiments of the present invention, a method for generating and providing hybrid content recommendations may include: collaboratively arranging one or more recommendation engines based on the conditions of a recommendation request; and utilizing the collaborative recommendation engine arrangement to generate a set of content recommendations.

According to some embodiments, conditions of a recommendation request may include at least: (1) a quantity of available information relating to the recommendation requestor(s), and (2) a quantity of available information relating to recommendable content from one or more content catalogs or repositories.

According to some embodiments, utilizing the collaborative recommendation engine arrangement may include: utilizing a first recommendation engine to generate a first set of content recommendations for a viewer, utilizing at least a second recommendation engine to generate at least a second set of content recommendations for the viewer, and selectively aggregating the first and the at least second recommendation sets into a blended final recommendation set.

According to some embodiments, a reliability value may be estimated for one or more recommendations within one or more of the recommendation sets. Recommendation sets may be selectively aggregated by factoring the reliability value of at least one recommendation. Only content recommendations with an estimated reliability value above a static or dynamically set threshold value/level may be selected for inclusion in the blended final recommendation set.

According to some embodiments, utilizing the collaborative recommendation engine arrangement may include: utilizing a first recommendation engine to generate one or more characterization tags for one or more content items, and utilizing at least a second recommendation engine to cross-correlate the one or more characterization tags on the one or more content items with a viewer's known preferences, in order to determine whether the one or more content items should be included in a recommendation set.

According to some embodiments, generating one or more characterization tags for one or more content items may include: feature identification in the content items, using an identifier on the content items to search through online descriptions of the content items and the use of natural language processing techniques to extract characterization information from the online descriptions, and/or copying characterization tags from other content items when both content items were marked as similar by a third recommendation engine (e.g. a collaborative filtering engine).

According to some embodiments, utilizing the collaborative recommendation engine arrangement may include: utilizing a first recommendation engine to generate a pre-defined viewer taste profile, based on external and environmental factors related to his recommendation request(s) and to generate one or more initial recommendation sets based on the pre-defined viewer taste profile; and utilizing at least a second recommendation engine to update and personalize the viewer taste profile, based on incoming user inputs, and generate one or more incrementally personalized recommendation sets based on the updated viewer taste profile.

According to some embodiments, utilizing the collaborative recommendation engine arrangement may include: utilizing a first recommendation engine to aggregate and standardize raw content-related data, and cluster it into data sets under, logically equal, abstract content items, and utilizing a second recommendation engine to generate content recommendations based on the standardized and clustered data sets, regardless of their raw data sources. Generating content recommendations may include scoring and selecting content items for recommendation, based on characterization tags of other, statistically similar, content items.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method for generating and providing hybrid content recommendations comprising:
collaboratively arranging one or more recommendation engines based on the conditions of a recommendation request; and
utilizing the collaborative recommendation engine arrangement to generate a set of content recommendations.

2. The method according to claim 1 wherein conditions of a recommendation request include at least (1) a quantity of available information relating to the recommendation requestor(s), and (2) a quantity of available information relating to recommendable content from one or more content catalogs or repositories.

3. The method according to claim 1 wherein utilizing the collaborative recommendation engine arrangement comprises:
utilizing a first recommendation engine to generate a first set of content recommendations for a viewer;
utilizing at least a second recommendation engine to generate at least a second set of content recommendations for the viewer; and
selectively aggregating the first and the at least second recommendation sets into a blended final recommendation set.

4. The method according to claim 3, further comprising estimating a reliability value for one or more recommendations within one or more of the recommendation sets.

5. The method according to claim 4, wherein selective aggregation of recommendation sets includes factoring the reliability value of at least one recommendation.

6. The method according to claim 5 wherein only content recommendations with an estimated reliability value above a static or dynamically set threshold value/level are selected for inclusion in the blended final recommendation set.

7. The method according to claim 1 wherein utilizing the collaborative recommendation engine arrangement comprises:
utilizing a first recommendation engine to generate one or more characterization tags for one or more content items; and
utilizing at least a second recommendation engine to cross-correlate the one or more characterization tags on the one or more content items with a viewer's known preferences in order to determine whether the one or more content items should be included in a recommendation set.

8. The method according to claim 7 wherein generating one or more characterization tags for one or more content items comprises feature identification in the content items.

9. The method according to claim 7 wherein generating one or more characterization tags for one or more content items comprises using an identifier on the content items to search through online descriptions of the content items and the use of natural language processing techniques to extract characterization information from the online descriptions.

10. The method according to claim 7 wherein generating one or more characterization tags for one or more content items comprises copying characterization tags from other content items when both content items were marked as similar by a third recommendation engine.

11. The method according to claim 10 wherein the third engine is a collaborative filtering engine.

12. The method according to claim 1 wherein utilizing the collaborative recommendation engine arrangement comprises:
utilizing a first recommendation engine to generate a pre-defined viewer taste profile, based on external and environmental factors related to his recommendation request(s), and to generate one or more initial recommendation sets based on the pre-defined viewer taste profile; and
utilizing the at least second recommendation engine to update and personalize the viewer taste profile, based on incoming user inputs, and generate one or more incrementally personalized recommendation sets based on the updated viewer taste profile.

13. The method according to claim 1 wherein utilizing the collaborative recommendation engine arrangement comprises:
utilizing a first recommendation engine to aggregate and standardize raw content-related data, and cluster it into data sets under, logically equal, abstract content items.

14. The method according to claim 13 further comprising utilizing a second recommendation engine to generate content recommendations based on the standardized and clustered data sets, regardless of their raw data sources.

15. The method according to claim 14 wherein generating content recommendations includes scoring and selecting content items for recommendation, based on characterization tags of other, statistically similar, content items.
